(19) United States
(12) Patent Application Publication
(10) Pub. No.: US 2012/0246373 A1
(43) Pub. Date: Sep. 27, 2012

(54) PCI-E BUS BASED CONNECTOR EXPANSION MODULE

(76) Inventor: Nai-Chien CHANG, New Taipei City (TW)

(21) Appl. No.: 13/402,881

(22) Filed: Feb. 23, 2012

(30) Foreign Application Priority Data
Mar. 22, 2011 (TW) 100205109

(51) Int. Cl. G06F 13/00

(52) U.S. Cl. 710/301

(57) ABSTRACT

A PCI-E bus based USB connector expansion module includes a first circuit board, a plurality of transmission wires, and at least one USB connector. The first circuit board has a welding part and a protruding part extending from one end of the welding part, and sharp and size of the protruding part are corresponding to that of a PCI-E bus slot, and the protruding part is arranged a plurality of golden fingers thereon. When the expansion module connects with the PCI-E bus, the protruding part is placed in the PCI-E bus slot, and the golden fingers electrically connect with a plurality of pins in the PCI-E bus slot. The transmission wires weld to the welding part separately at one end, and electrically connect to the at least one USB connector on other end.

### BACKGROUND OF THE INVENTION

1. Field of the Invention

The invention related to an expansion module, and in particular to an expansion module which can expand USB connectors.

2. Description of Prior Art

Universal serial bus (USB) is a transmission interface proposed by Intel corporation and Microsoft corporation, and USB now is generally known and used in personal computer peripherals.

So far, the USB interface develops from USB1.0, USB1.1, to USB2.0 edition. In particularly, USB1.0 supports a low speed mode with 1.5 Mbps transmission rate; USB1.1 supports a full speed mode with 12 Mbps transmission rate; and USB2.0 supports a hi-speed mode with 480 Mbps transmission rate.

However, the 480 Mbps transmission rate provided by the USB 2.0 interface can't satisfies some specific purposes in this day, as a result to solve this problem, a USB 3.0 edition is now developed. The USB3.0 supports a super speed mode with 5 Gbps transmission rate. The USB 3.0 interface totally has nine terminals, which is based on four terminals in the USB 2.0 interface, and is further added with two couples of signal pins and one ground pin, and the USB 3.0 edition is downward compatible to USB 2.0 edition.

The computer motherboard can't uses a USB connector unless it arranges a corresponding control IC thereon, however, the USB 3.0 interface is not so popular now, so the motherboard including a USB 3.0 control IC thereon is very scarce in the market. In this circumstance, most of the computer users have their own computer motherboard which can't support the usage of the USB 3.0 connector.

For solving the above problem, there comes a USB 3.0 expansion interface card. FIG. 1 shows a perspective view of an expansion interface card according to prior art. The expansion interface card 10 mainly includes a printed circuit board (PCB), where a control IC 101 and at least one USB 3.0 connector 102 are arranged on the PCB, and the at least one USB 3.0 connector 102 electrically connects to the control IC 101.

The expansion interface card 10 extends a protruding part 103 on one side, and a plurality of golden fingers 104 are arranged on the protruding part 103 and electrically connected to the control IC 101. Further, the sharp and the size of the protruding part 103 are corresponding to that of a peripheral component interconnector express (PCI-E) ×1 bus 201 slot on a computer motherboard 200. When the protruding part 103 inserts into the slot of the PCI-E ×1 bus 201, the expansion interface card 10 can electrically connect to the PCI-E xl bus 201 through the golden fingers 104. When the expansion interface card 10 electrically connects to the motherboard 200 through the PCI-E ×1 bus 201, the computer owning the motherboard 200 can connect an external electrical device having USB 3.0 interface (not shown) via the expansion interface card 10 and then use the external electrical device, so as to transmit and receive signal through USB 3.0 interface.

However, when the USB 3.0 interface becomes popular in future, the computer motherboard should arrange the USB 3.0 control IC thereon, and the expansion interface card 10 mentioned above will not be needed anymore. The expansion interface card 10 is very expensive, and the expansion interface card 10 has a large volume that occupies much of the arrange space on the motherboard when it is inserted in the PCI-E bus 201.

As mentioned above, it is considered that how to expand more USB 3.0 connectors through the PCI-E bus in the circumstance that has more convenience, cheaper cost, and less space occupied. Further, the possibility arrangement position of the connector is increased, it also provides the convenience of usage.

### SUMMARY OF THE INVENTION

The present invention is to provide a PCI-E bus based USB connector expansion module for inserting into a PCI-E bus slot on a motherboard of an electronic device, so the electronic device can expand USB connectors via its PCI-E interface.

In order to achieve the above object, the expansion module of the present invention includes a first circuit board, a plurality of transmission wires, and at least one USB connector. The first circuit board has a welding part and a protruding part which extends from one end of the welding part, and sharp and size of the protruding part are corresponding to that of a PCI-E bus slot, and the first circuit board arranges a plurality of golden fingers on the protruding part. When the expansion module connects with the PCI-E bus, the protruding part is placed in the PCI-E bus slot, and the golden fingers on the protruding part electrically connect with a plurality of pins in the PCI-E bus slot. The transmission wires weld the welding part of the first circuit board on one end, so as to electrically connect to the golden fingers on the protruding part separately. Further, other end of the transmission wires electrically connects the at least one USB connector.

In comparing with prior art, the present invention can be used to expand USB connectors directly via PCI-E bus on the computer motherboard, the motherboard which is connected with needs not to reserve a certain arrangement space for setting the USB connectors, so the arrangement space on the motherboard can be saved. Further, the expanded USB connectors can extend to front end of the computer via the transmission wires in the present invention. The expansion module can be used as a front line. As a result, the convenience of connectors' usage can be raised.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a perspective view of expansion interface card according to prior art.

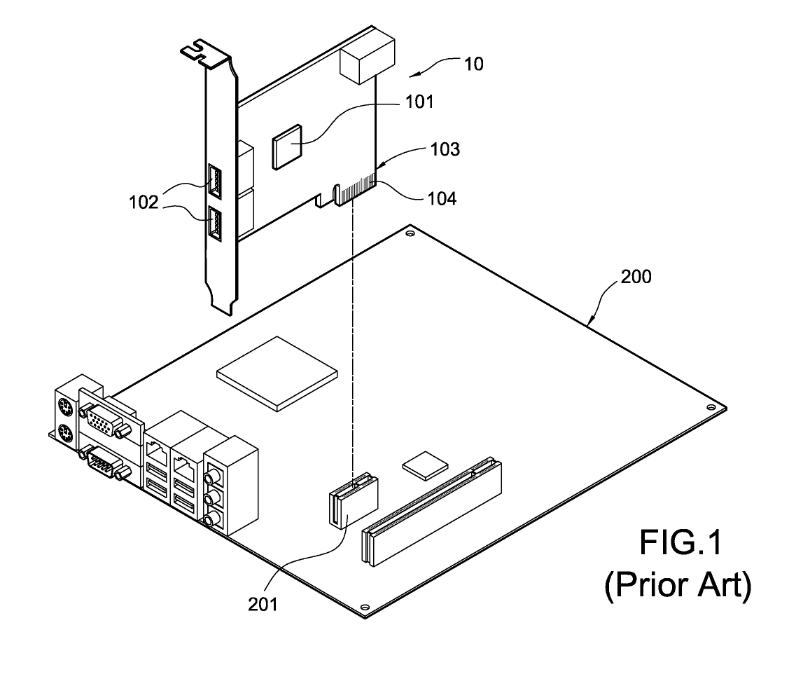

FIG. 2 is a perspective view of a first embodiment according to the present invention.

FIG. 3 is a perspective view of a second embodiment according to the present invention.

FIG. 4 is a perspective view of connection of a first embodiment according to the present invention.

FIG. 5 is a perspective view of a third embodiment according to the present invention.

FIG. 6 is a perspective view of a fifth embodiment according to the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

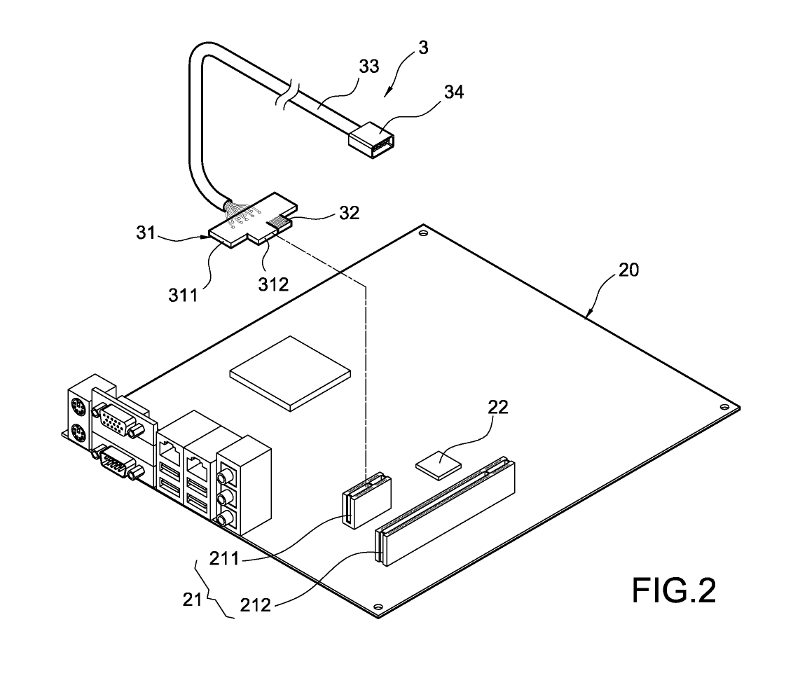

FIG. 2 is a perspective view of a first embodiment according to present invention. A USB connector expansion module 3 (referred to as the expansion module 3 hereinafter) of the present invention is mainly utilized on a motherboard 20 of a computer, the motherboard 20 mainly includes at least one peripheral component interconnect express (PCI-E) bus 21 and at least one control integrated circuit (IC) 22 which is electrically connected to the PCI-E bus 21.

The PCI-E bus 21 mentioned above is a PCI-E ×1 bus 211, a PCI-E ×16 bus 212, or another species of PCI-E bus (not shown); the control IC 22 can be a universal serial bus (USB) 3.0 control IC for example, but not limited. In the following descriptions, the PCI-E bus 21 will be illustrated as the PCI-E ×1 bus 211.

The expansion module 3 in the embodiment mainly has a first circuit board 31, a plurality of transmission wires 33, and at least one USB connector 34. The plurality of transmission wires 33 are usually coated together with an insulation material, so as to reduce signal interference, and to provide arrangement convenience for user. In FIG. 2, the plurality of transmission wires 33 are illustrated as one thick transmission wire 33.

The first circuit board 31 has a welding part 311 and a protruding part 312 which is protruded from the welding part 311. The shape and the size of the protruding part 312 are corresponding to that of the PCI-E ×1 bus 211 slot, and the first circuit board 31 arranges a plurality of golden fingers 32 on the protruding part 312.

When the first circuit board 31 connects with the PCI-E ×1 bus 211, the protruding part 312 of the first circuit board 31 is placed in the slot of the PCI-E ×1 bus 211, therefore, the plurality of golden fingers 32 on the protruding part 312 electrically connect with a plurality of pins of the PCI-E ×1 bus 211 separately. In particularly, the position of the plurality of golden fingers 32 on the protruding part 312 is corresponding to the position of the pins in the PCI-E ×1 bus 211.

The amount of the plurality of transmission wires 33 is corresponding to that of the plurality of golden fingers 32, and one end of each transmission wire 33 is welded to the welding part 311 of the first circuit board 31 separately, so as to electrically connect to the golden fingers 32. The at least one USB connector 34 electrically connects to other end of the plurality of transmission wires 33.

In this embodiment, the USB connector 34 can be a USB 3.0 connector for example, which has nine terminals therein (now shown). The nine terminals electrically connects to the other end of the transmission wires 33 separately, so as to electrically connect to the golden fingers 32 through the transmission wires 33, and further electrically connect to the pins of the PCI-E ×1 bus 211 through the golden fingers 32.

In particularly, the amount of the transmission wires 33 and the golden fingers 32 are both a multiple of nine, and the value of the multiple is corresponding to the amount of the USB connector 34. In other words, every nine transmission wires 33 and nine golden fingers 32 are corresponding to one USB connector 34.

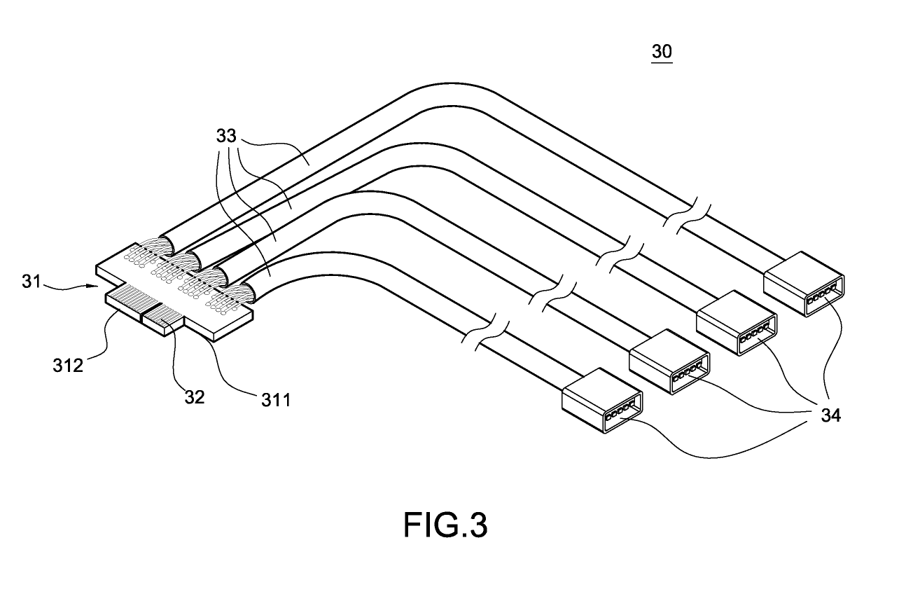

FIG. 3 is a perspective view of a second embodiment according to the preset invention. As mentioned above, the PCI-E ×1 bus 211 has thirty-six pins therein. The amount of the golden fingers 32 on the first circuit board 31 is corresponding to that of the pins, which is thirty-six at most. In particularly, eighteen golden fingers 32 are arranged on one side of the protruding part 312 of the first circuit board 31, and the other eighteen golden fingers 32 are arranged on other side of the protruding part 312. Further, the amount of the transmission wires 33 is corresponding to that of the golden fingers 32, which is thirty-six at most, too.

The USB connector 34 is illustrated as a USB 3.0 connector which has nine terminals in this embodiment. It means that one PCI-E bus ×1 211 can expand four USB 3.0 connectors through the expansion module 30 of the present invention.

As shown in FIG. 3, the amount of the golden fingers 32 is thirty-six, and the thirty-six golden fingers 32 are corresponding to the thirty-six pins in the PCI-E ×1 bus 211 separately. The amount of the transmission wires 33 is also thirty-six, and the thirty-six transmission wires 33 are divided into four groups corresponding to four USB connectors 34 separately.

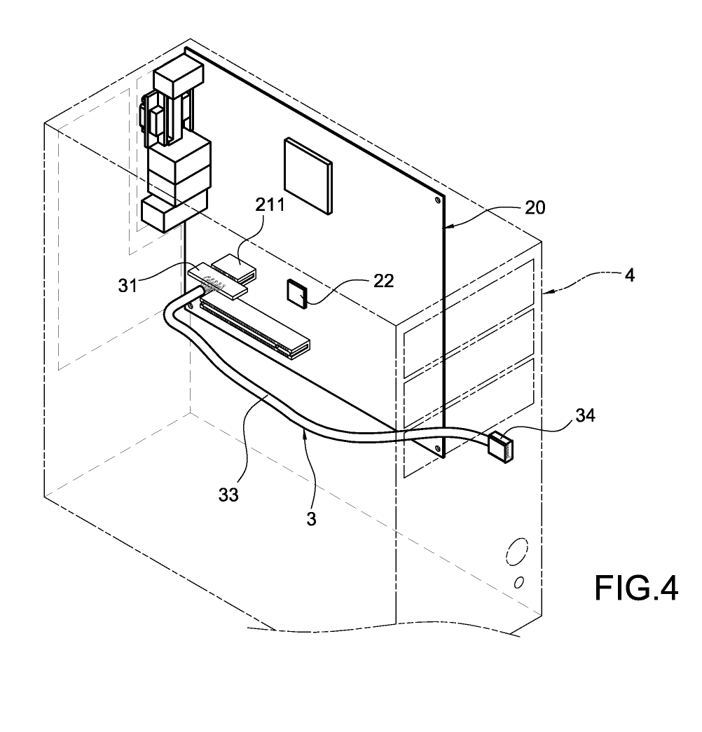

FIG. 4 is a perspective view of connection of a first embodiment according to the present invention. If a motherboard 20 on a computer 4 has the PCI-E ×1 bus 211 and the USB 3.0 control IC 22 thereon, the computer 4 can certainly use the expansion module 3 in the present invention. When connecting with the PCI-E ×1 bus 211, the expansion module 3 can further extend the USB connector 34 to front end of the computer 4 through the plurality of transmission wires 33. Therefore, the expansion module 3 can be utilized as a front line, so as to provide the convenience for usage.

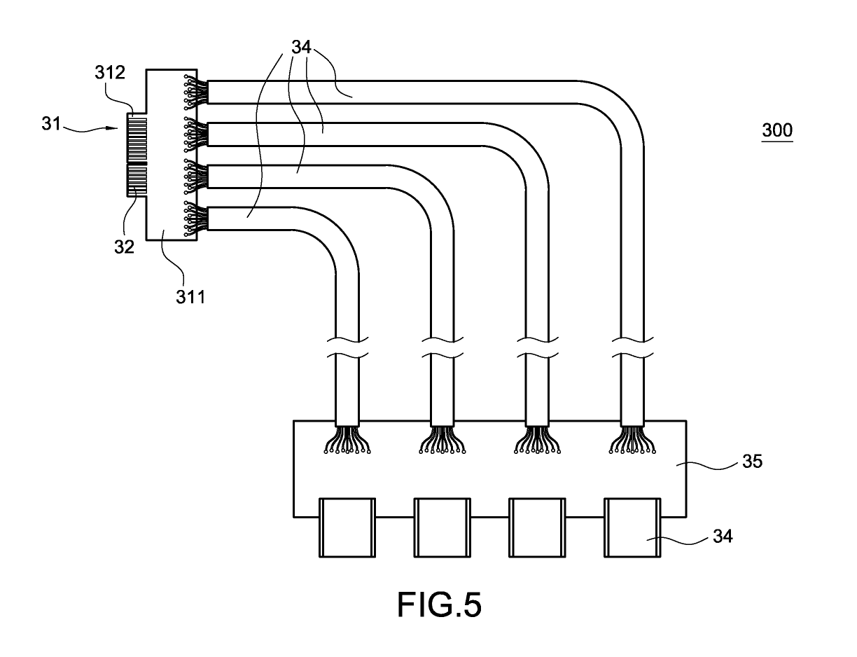

FIG. 5 is a perspective view of a third embodiment according to the present invention. An expansion module 300 is disclosed in this embodiment. The expansion module 300 has the same first circuit board 31, the plurality of transmission wires 33, and the at least one USB connector 34 included in the expansion module 30 described above, and the expansion module 300 further includes a second circuit board 35. One end of the second circuit board 35 connects with the other end of the plurality of transmission wires 33, and the USB connector 34 connects to other end of the second circuit board 35 which is away from the transmission wires 33. In particularly, the USB connector 34 is illustrated as a USB 3.0 connector which has nine terminals therein, and each of the USB connector 34 electrically connects nine transmission wires 33 through the second circuit board 35.

As a result, the second circuit board 35 of the expansion module 300 makes the connection between the plurality of transmission wires 33 and the at least one USB connector 34 easier, and the second circuit board 35 also makes the arrangement of the expansion module 300 on the computer 4 more stable.

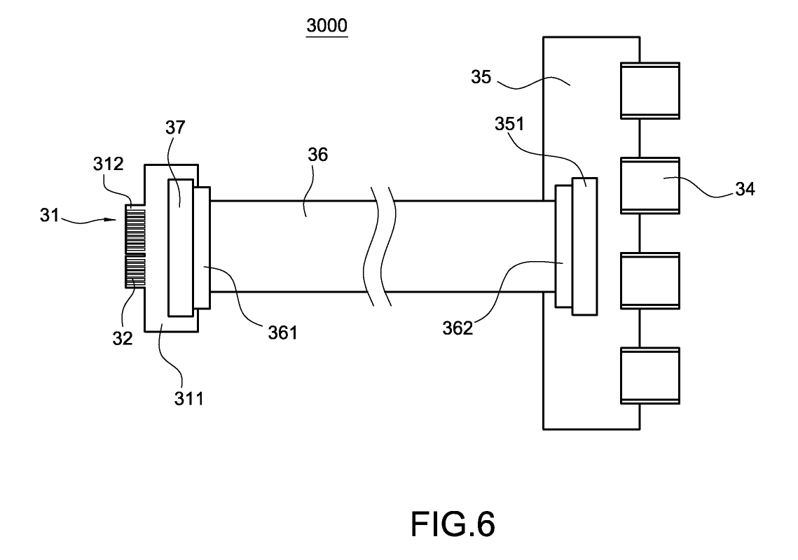

FIG. 6 is a perspective view of a forth embodiment according to the present invention. An expansion module 3000 is disclosed in this embodiment, the expansion module 3000 has the same first circuit board 31, the at least one USB connector 34, and the second circuit board 35 in the expansion module 300 described above. Further, the expansion module 3000 replaces the plurality of transmission wires 33 in the expansion module 300 with a cable 36, and in particularly, the cable 36 is a flexible flat cable (FFC), but not intended to limit the scope of the present invention.

The cable 36 has a first connection piece 361 at one end, and has a second connection piece 362 at the other end which is away from the first connection piece 361. The first circuit board 31 has a first connection part 37 at the welding part 311, the cable 36 electrically connects to the first circuit board 31 through the first connection piece 361 and the first connection part 37, so as to electrically connects to the plurality of golden fingers 32 on the protruding part 312 of the first circuit board 31. The second circuit board 35 has a second connection part 351 at one end, and the second circuit board 35 electrically connects with the cable 36 through the second connection part 351 and the second connection piece 362 of the cable 36. The at least one USB connector 34 electrically connects to the other end of the second circuit board 35 which is away from the second connection part 351, therefore, the USB connector 34 electrically connects to the cable 36 through the second circuit board 35.

In the embodiment, if the USB connector 34 is a USB 3.0 connector which has nine terminals in this embodiment, then each USB connector 34 electrically connects to nine golden fingers separately through the second circuit board 35 and the cable 36. In particularly, the amount of the golden fingers 32 is a multiple of nine, and the value of the multiple is corresponding to the amount of the USB connector 34. Further, the amount of the USB connector 34 is four at most, and the amount of the golden fingers 32 is thirty-six at most.

Although the present invention has been described with reference to the foregoing preferred embodiments, it will be understood that the invention is not limited to the description thereof. Any equivalent variations and modifications can be made to those skilled in the art in view of the teaching of the present invention are also in the scope of the invention as defined in the appended claims.

What is claimed is:

1. A PCI-E bus based USB connector expansion module for connecting a peripheral component interconnect express (PCI-E) bus on a computer motherboard, the motherboard having a universal serial bus (USB) 3.0 control integrated circuit (IC), and the control IC electrically connected to the PCI-E bus, the USB connector expansion module comprises:
a first circuit board having a welding part and a protruding part extending from one end of the welding part, and sharp and size of the protruding part being corresponding to that of the PCI-E bus slot, a plurality of golden fingers arranged on the protruding part, and position of the golden fingers on the protruding part being corresponding to that of pins on the PCI-E bus;
a plurality of transmission wires, amount of the transmission wires being corresponding to that of the golden fingers, and one end of the transmission wires welded to the welding part of the first circuit board separately for electrically connecting with the golden fingers through the first circuit board; and
at least one USB connector electrically connected to other end of the transmission wires;
wherein, the protruding part is placed in the PCI-E bus slot and the golden fingers are electrically connected to pins in the PCI-E bus when the first circuit board connecting to the PCI-E bus.

2. The USB connector expansion module according to claim 1, wherein the at least one USB connector is a USB 3.0 connector, each USB connector electrically connects nine transmission wires, and the amount of the transmission wires and golden fingers are a multiple of nine, and the value of the multiple is corresponding to the amount of the USB connector.

3. The USB connector expansion module according to claim 2, wherein the amount of the USB connector is four at most, and the amount of the transmission wires and the golden fingers are both thirty-six at most.

4. The USB connector expansion module according to claim 1, further includes a second circuit board, one end of the second circuit board electrically connects to other end of the transmission wires, and the at least one USB connector electrically connects to other end of the second circuit board which is away from the transmission wires, and the transmission wires electrically connect to the at least one USB connector through the second circuit board.

5. The USB connector expansion module according to claim 4, wherein the at least one USB connector is a USB 3.0 connector, each USB connector electrically connects nine transmission wires through the second circuit board, and the amount of the transmission wires and golden fingers are a multiple of nine, and the value of the multiple is corresponding to the amount of the USB connector.

6. The USB connector expansion module according to claim 5, wherein the amount of the USB connector is four at most, and the amount of the transmission wires and the golden fingers are both thirty-six at most.

7. A PCI-E bus based USB connector expansion module for connecting a PCI-E bus on a computer motherboard, the motherboard having a USB 3.0 control IC, and the control IC electrically connected to the PCI-E bus, the USB connector expansion module comprises:
a first circuit board having a welding part and a protruding part extending from one end of the welding part, the welding part having a first connection part thereon, sharp and size of the protruding part being corresponding to that of the PCI-E bus slot, a plurality of golden fingers arranged on the protruding part, and position of the golden fingers on the protruding part being corresponding to that of pins on the PCI-E bus;
a cable having a first connection piece at one end and a second connection piece at other end, the cable electrically connected to the first circuit board through the first connection piece and the first connection part for electrically connecting to the golden fingers on the protruding part;
a second circuit board having a second connection part on one end, and the second circuit board electrically connected to the cable through the second connection part and the second connection piece on the cable; and
at least one USB connector electrically connected to other end of the second circuit board which being away from the second connection part, and the USB connector electrically connected to the cable through the second circuit board;
wherein, the protruding part is placed in the PCI-E bus slot, and the golden fingers are electrically connected to pins in the PCI-E bus when the first circuit board connecting to the PCI-E bus.

8. The USB connector expansion module according to claim 7, wherein the cable is a flexible flat cable (FFC).

9. The USB connector expansion module according to claim 8, wherein the at least one USB connector is a USB 3.0 connector, each USB connector electrically connects nine golden fingers on the first circuit board through the second circuit board and the cable, and the amount of the golden fingers is a multiple of nine, and the value of the multiple is corresponding to the amount of the USB connector.

10. The USB connector expansion module according to claim 9, wherein the amount of the USB connector is four at most, and the amount of the golden fingers is thirty-six at most.
